(19) United States
(12) Patent Application Publication
(10) Pub. No.: US 2021/0127125 A1
(43) Pub. Date: Apr. 29, 2021

(54) REDUCING SIZE AND POWER CONSUMPTION FOR FRAME BUFFERS USING LOSSY COMPRESSION

(71) Applicant: Facebook Technologies, LLC, Menlo Park, CA (US)

(72) Inventors: Vlad Fruchter, Los Altos, CA (US); Richard Lawrence Greene, Kirkland, WA (US); Richard Webb, Sammamish, WA (US)

(21) Appl. No.: 16/661,731

(22) Filed: Oct. 23, 2019

(51) Int. Cl. H04N 19/423; H04N 19/51; H04N 19/46

(52) U.S. Cl. CPC H04N 19/423; H04N 19/46; H04N 19/51

(57) ABSTRACT

Disclosed herein a system, a method and a device for reducing a size and power consumption in encoder and decoder frame buffers using lossy compression. An encoder of a first device can provide a first video frame for encoding, to a prediction loop of the first device. In the prediction loop, lossy compression can be applied to the first video frame to generate a first compressed video frame. In the prediction loop, lossy decompression can be applied to the first compressed video frame. The encoder can provide, to a decoder of a second device to perform decoding, encoded video data corresponding to the first video frame and a configuration of the lossy compression.

### FIELD OF DISCLOSURE

The present disclosure is generally related to display systems and methods, including but not limited to systems and methods for reducing power consumption in encoder and decoder frame buffers using lossy compression.

### BACKGROUND

In video streaming technologies, a video having a plurality of video frames can be encoded and transmitted from an encoder on a transmit device to a decoder on a receive device, to be decoded and provided to different applications. During the encoding and decoding, the video frames forming the video can require large memory availability and large amounts of power to process to the respective video frames. For example, lossless compression can be used at an encoder or decoder to process the video frames. However, the lossless compression ratios can vary from frame to frame and are typically small. Further, the lossless compression can provide a variable output size and utilize a large memory footprint, as the memory buffers are sized to account for a worst case scenario.

### SUMMARY

Devices, systems and methods for reducing a size and power consumption in encoder and decoder frame buffers using lossy compression is provided herein. The size and/or power consumption used during read and write operations to the frame buffers of an encoder portion and/or a decoder portion of a video transmission system can be reduced by applying lossy compression algorithms in a prediction loop connected to the encoder portion and/or a reference loop connected to the decoder portion respectively. In a video transmission system, a transmit device can include an encoder, a prediction loop and a storage device (e.g., frame buffer), and a receive device can include an encoder, a prediction loop and a storage device (e.g., frame buffer). A lossy compression algorithm can be applied by the prediction loop at the encoder portion of the transmit device to reduce a size of the memory sufficient to write the compressed video frame to the storage device of the transmit device. In some embodiments, the reduced memory footprint needed for the frame buffer can translate to the use of memory circuitry with reduced power consumption for read/write operations. For example, the frame buffer can be stored in an internal (e.g., on-chip, internal to the transmit device) static random access memory (SRAM) component to reduce the power consumption needs of the transmit device. At the receive device, a lossy compression algorithm can be applied by the reference loop at the decoder portion to reduce a size of the memory sufficient to write the compressed video frame to the storage device of the receive device. The lossy compression algorithm applied at the transmit device and the receive device can have the same compression ratio. In some embodiments, a lossy decompression algorithm applied at the transmit device and the receive device (e.g., on the same video frame(s)) can have the same decompression ratio. The reduced memory footprint for the frame buffer of the receive device can provide or allow for the frame buffer to be stored in an internal (e.g., on-chip) SRAM component at the receive device. Thus, the transmit device and receive device can use lossy compression algorithms having matching compression ratios in a prediction loop and/or a reference loop to reduce the size of video encoder and decoder frame buffers.

In at least one aspect, a method is provided. The method can include providing, by an encoder of a first device, a first video frame for encoding, to a prediction loop of the first device. The method can include applying, in the prediction loop, lossy compression to the first video frame to generate a first compressed video frame. For example, the first video frame can correspond to a reference frame or an approximation of a previous video frame. The method can include applying, in the prediction loop, lossy compression to a reference frame that is an approximation of the first video frame or previous video frame to generate a first compressed video frame that can be decoded and used as the reference frame for encoding the next video frame. The method can include applying, in the prediction loop, lossy decompression to the first compressed video frame. The method can include applying, in the prediction loop, lossy decompression to the first compressed video frame or a previous (N−1) compressed video frame. The method can include providing, by the encoder to a decoder of a second device to perform decoding, encoded video data corresponding to the first video frame and a configuration of the lossy compression.

In embodiments, the method can include receiving, by the encoder, a second video frame subsequent to the first video frame. The method can include receiving, from the prediction loop, a decompressed video frame generated by applying the lossy decompression to the first video frame. The method can include estimating, by a frame predictor of the encoder, a motion metric according to the second video frame and the decompressed video frame. The method can include predicting the second video frame based in part on a reconstruction (e.g., decompression) of the first video frame or a previous video frame to produce a prediction of the second video frame. In embodiments, the method can include encoding, by the encoder, the first video frame using data from one or more previous video frames, to provide the encoded video data. The method can include transmitting, by the encoder, the encoded video data to the decoder of the second device.

The method can include causing the decoder to perform decoding of the encoded video data using the configuration of the lossy compression. The method can include causing the second device to apply lossy compression in a reference loop of the second device, according to the configuration. The method can include transmitting the configuration in at least one of: subband metadata, a header of a video frame transmitted from the encoder to the decoder, or a handshake message for establishing a transmission channel between the encoder and the decoder.

In embodiments, the method can include decoding, by a decoder of the second device, the encoded video data to generate a decoded video frame. The method can include combining, by the second device using a reference loop of the second device, the decoded video frame and a previous decoded video frame provided by the reference loop of the second device to generate a decompressed video frame associated with the first video frame. For example, the method can include combining the decoded residual with the decoded reference frame for the previous decoded video frame to generate a second or subsequent decompressed video frame. The method can include storing the first compressed video frame in a storage device in the first device rather than external to the first device. The method can include storing the first compressed video frame in a static random access memory (SRAM) in the first device rather than a dynamic random access memory (DRAM) external to the first device. The configuration of the lossy compression can include at least one of a compression rate of the lossy compression, a decompression rate of the lossy decompression, a loss factor, a quality metric or a sampling rate. The method can include configuring the lossy compression applied in the prediction loop of the first device and lossy compression applied by a reference loop of the second device to have a same compression rate to provide bit-identical results.

In at least one aspect, a device is provided. The device can include at least one processor and an encoder. The at least one processor can be configured to provide a first video frame for encoding, to a prediction loop of the device. The at least one processor can be configured to apply, in the prediction loop, lossy compression to the first video frame to generate a first compressed video frame. The at least one processor can be configured to apply, in the prediction loop, lossy decompression to the first compressed video frame. The encoder can be configured to provide, to a decoder of another device to perform decoding, encoded video data corresponding to the first video frame and a configuration of the lossy compression.

In embodiments, the first compressed video frame can be stored in a storage device in the device rather than external to the device. The first compressed video frame can be stored in a static random access memory (SRAM) in the device rather than a dynamic random access memory (DRAM) external to the device. The at least one processor can be configured to cause the decoder to perform decoding of the encoded video data using the configuration of the lossy compression. The at least one processor can be configured to cause the another device to apply lossy compression in a reference loop of the another device, according to the configuration. The configuration of the lossy compression can include at least one of a compression rate of the lossy compression, a decompression rate of the lossy decompression, a loss factor, a quality metric or a sampling rate. The at least one processor can be configured to cause lossy compression applied by a prediction loop of the another device to have a same compression rate as the lossy compression applied in the prediction loop of the device to provide bit-identical results.

In at least one aspect, a non-transitory computer readable medium storing instructions is provided. The instructions when executed by one or more processors can cause the one or more processors to provide a first video frame for encoding, to a prediction loop of the device. The instructions when executed by one or more processors can cause the one or more processors to apply, in the prediction loop, lossy compression to the first video frame to generate a first compressed video frame. The instructions when executed by one or more processors can cause the one or more processors to apply, in the prediction loop, lossy decompression to the first compressed video frame. The instructions when executed by one or more processors can cause the one or more processors to provide, to a decoder of another device to perform decoding, encoded video data corresponding to the first video frame and a configuration of the lossy compression. In embodiments, the instructions when executed by one or more processors can cause the one or more processors to cause the decoder to perform decoding of the encoded video data using the configuration of the lossy compression.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram of an embodiment of a system for reducing a size and power consumption in encoder and decoder frame buffers using lossy frame buffer compression, according to an example implementation of the present disclosure.

FIGS. 2A-2D include a flow chart illustrating a process or method for reducing a size and power consumption in encoder and decoder frame buffers using lossy compression, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

For purposes of reading the description of the various embodiments of the present invention below, the following descriptions of the sections of the specification and their respective contents may be helpful:
Section A describes embodiments of devices, systems and methods for reducing a size and power consumption in encoder and decoder frame buffers using lossy compression.
   A. Reducing a Size and Power Consumption in Encoder and Decoder Frame Buffers using Lossy Compression

The subject matter of this disclosure is directed to a technique for reducing power consumption and/or size of memory for buffering video frames for encoder and decoder portions of a video transmission system. In video processing or video codec technology, lossless compression can be used to reduce a DRAM bandwidth for handling these video frames. The lossless compression provides compatibility with many commercial encoders and can prevent error accumulation across multiple frames (e.g., P frames, B frames). However, the lossless compression ratios can vary from frame to frame and are typically small (e.g., 1-1.5× compression rate). Therefore, lossless compression can provide a variable output size and utilizes a large memory footprint, as the memory buffers are sized to account for a worst case scenario (e.g., 1× compression rate).

In embodiments, the video processing can begin with a key current video frame or I-frame (e.g., intra-coded frame) received and encoded on its own or independent of a predicted frame. The encoder portion can generate predicted video frames or P-frames (e.g., predicted frames) iteratively. The decoder portion can receive the I-frames and P-frames and reconstruct a video frame iteratively by reconstructing the predicted frames (e.g., P-frames) using the current video frames (e.g., I-frames) as a base.

The systems and methods described herein use lossy compression of frame buffers within a prediction loop for frame prediction and/or motion estimation, for each of the encoder and decoder portions of a video transmission system, to reduce power consumption during read and write operations, and can reduce the size of the frame buffer memory that can support the encoder and decoder. For example, a prediction loop communicating with an encoder or a reference loop communicating with a decoder can include lossy compression and lossy decompression algorithms that can provide a constant output size for compressed data, and can reduce the frame buffer memory size for read and write operations at the frame buffer memory during encoding or decoding operations. The lossy compression can reduce the system power consumption and potentially avoid the use of external DRAM to buffer video frames. For example, the lossy compression techniques described here can provide or generate compressed video data of a known size corresponding to a much reduced memory footprint that can be stored in an internal SRAM instead of (external) DRAM. In some embodiments, the frame buffer size can be reduced in a range from 4× to 8× the compression rate. Unlike lossless compression, the compression rate of the lossy compression can be controlled or tuned to provide a tradeoff between a frame buffer size and output quality (e.g., video or image quality).

In some embodiments, a video frame being processed through an encoder can be provided to a prediction loop of a frame predictor (e.g., motion estimator) of the encoder portion (sometimes referred to as encoder prediction loop), to be written to a frame buffer memory of the encoder portion. The encoder prediction loop can include or apply a lossy compression algorithm having a determined compression rate to the video frame prior to storing the compressed video frame in the frame buffer memory. The encoder prediction loop can include or apply a lossy decompression to a compressed previous video frame being read from the frame buffer memory, and provide the decompressed previous video frame unit to the encoder to be used, for example, in motion estimation of a current or subsequent video frame. In embodiments, the encoder can compare a current video frame (N) to a previous video frame (N−1) to determine similarities in space (e.g., intraframe) and time (e.g., motion metric, motion vectors). This information can be used to predict the current video frame (N) based on previous video frame (N−1). In embodiments, to prevent error accumulation across video frames, the difference between the original input frame and the predicted video frame (e.g., residual) can be lossy-compressed and transmitted as well.

The video transmission system can include a decoder portion having a reference loop (sometimes referred to as decoder reference loop) that can provide matching lossy frame buffer compression and lossy frame buffer decompression as compared to the lossy compression and lossy decompression of the encoder portion. For example, an output of the decoder corresponding to a video frame can be provided to the reference loop of the decoder. The decoder reference loop can apply a lossy compression to a reference frame having the same determined compression rate and/or parameters as the encoder prediction loop, to the video frame, and then store the compressed video frame in the frame buffer memory of the decoder portion. The decoder reference loop can apply a lossy decompression to a compressed previous video frame that is read from the frame buffer memory, and provide the decompressed previous video frame to the decoder to be used, for example, in generating a current video frame for the video transmission system. The compression rates and/or properties of the lossy compression and decompression at both the encoder and decoder portions can be matched exactly to reduce or eliminate drift or error accumulation across the video frames (e.g., P frames) processed by the video transmission system. The matched lossy compression can be incorporated into the prediction loop of the encoder portion and the reference loop of the decoder portion to reduce the memory footprint and allow for storage of the video frames in on-chip frame buffer memory, for example, in internal SRAM, thereby reducing power consumption for read and write operations on frame buffer memories. In embodiments, the lossy compressed reference frames can be used as an I-frame stream that can be transmitted to another device (e.g., decoder) downstream to provide high-quality compressed version of the video stream without transcoding, and the decoder can decode with low latency and no memory accesses as the decode can use only I-frames from the I-frame stream. In embodiments, the lossy frames can be used for storage of the corresponding video frames in case the video frames are to be persistent for some future access, instead of storing in an uncompressed format.

The encoder can share settings or parameters of the lossy compression, with the decoder via various means, such as in subband metadata, in header sections of transmitted video frames, or through handshaking to setup the video frame transmission between the encoder and the decoder. For example, the decoder can use an identical prediction model as the encoder to re-create a current video frame (N) based on a previous video frame (N−1). The decoder can use the identical settings and parameters to reduce or eliminate small model errors from accumulating over multiple video frames and protect video quality. Lossy compression cam be applied to both encoder and decoder frame buffers. The lossy compressor can be provided or placed within the encoder prediction loop. The encoder and decoder lossy compressors can be bit-identical and configured to have the same compression ratio (e.g., compression settings, compression parameters). In embodiments, the encoder and decoder lossy frame compressors can be matched to provide bit-identical results when operating at the same compression ratio. Therefore, the reconstructed frame error can be controlled by the encoder (e.g., the error is bounded and does not increase over time). For example, if the lossy frame compressions are not matched, the error can continue to accumulate from video frame to video frame and degrade video quality to unacceptable levels over time.

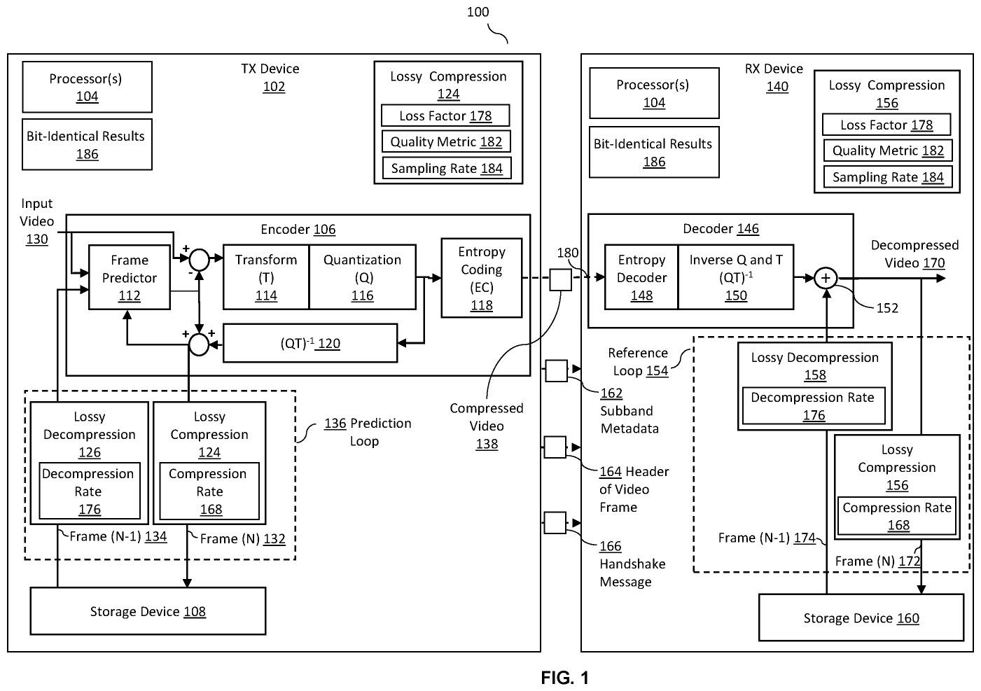

Referring now to FIG. 1, an example system 100 for reducing a size of encoder and decoder frame buffers, and a power consumption associated with encoder and decoder frame buffers using lossy compression, is provided. In brief overview, a transmit device 102 (e.g., first device 102) and a receive device 140 (e.g., second device 140) of a video transmission system 100 can be connected through one or more transmission channels 180 (e.g., connections) to process video frames 132 corresponding to a received video 130. For example, the transmit device 102 can include an encoder 106 to encode one or more video frames 132 of the received video 130 and transmit the encoded and compressed video 138 to the receive device 140. The receive device 140 can include a decoder 146 to decode the one or more video frames 172 of the encoded and compressed video 138 and provide a decompressed video 170 corresponding to the initially received video 130, to one or more applications connected to the video transmission system 100.

The transmit device 102 (referred to herein as a first device 102) can include a computing system or WiFi device. The first device 102 can include or correspond to a transmitter in the video transmission system 100. In embodiments, the first device 102 can be implemented, for example, as a wearable computing device (e.g., smart watch, smart eyeglasses, head mounted display), smartphone, other mobile phone, device (e.g., consumer device), desktop computer, laptop computer, a VR puck, a VR personal computer (PC), VR computing device, a head mounted device or implemented with distributed computing devices. The first device 102 can be implemented to provide virtual reality (VR), augmented reality (AR), and/or mixed reality (MR) experience. In some embodiments, the first device 102 can include conventional, specialized or custom computer components such as processors 104, a storage device 108, a network interface, a user input device, and/or a user output device.

The first device 102 can include one or more processors 104. The one or more processors 104 can include any logic, circuitry and/or processing component (e.g., a microprocessor) for pre-processing input data (e.g., input video 130, video frames 132, 134) for the first device 102, encoder 106 and/or prediction loop 136, and/or for post-processing output data for the first device 102, encoder 106 and/or prediction loop 136. The one or more processors 104 can provide logic, circuitry, processing component and/or functionality for configuring, controlling and/or managing one or more operations of the first device 102, encoder 106 and/or prediction loop 136. For instance, a processor 104 may receive data associated with an input video 130 and/or video frame 132, 134 to encode and compress the input video 130 and/or the video frame 132, 134 for transmission to a second device 140 (e.g., receive device 140).

The first device 102 can include an encoder 106. The encoder 106 can include or be implemented in hardware, or at least a combination of hardware and software. For example, the encoder 106 can include a device, a circuit, software or a combination of a device, circuit and/or software to convert data (e.g., video 130, video frames 132, 134) from one format to a second different format. In some embodiments, the encoder 106 can encoder and/or compress a video 130 and/or one or more video frames 132, 134 for transmission to a second device 140.

The encoder 106 can include a frame predictor 112 (e.g., motion estimator, motion predictor). The frame predictor 112 can include or be implemented in hardware, or at least a combination of hardware and software. For example, the frame predictor 112 can include a device, a circuit, software or a combination of a device, circuit and/or software to determine or detect a motion metric between video frames 132, 134 (e.g., successive video frames, adjacent video frames) of a video 130 to provide motion compensation to one or more current or subsequent video frames 132 of a video 130 based on one or more previous video frames 134 of the video 130. The motion metric can include, but not limited to, a motion compensation to be applied to a current or subsequent video frame 132, 134 based in part on the motion properties of a previous video frame 134. For example, the frame predictor 112 can determine or detect portions or regions of a previous video frame 134 that corresponds to or matches a portion or region in a current or subsequent video frame 132, such that the previous video frame 134 corresponds to a reference frame. The frame predictor 112 can generate a motion vector including offsets (e.g., horizontal offsets, vertical offsets) corresponding to a location or position of the portion or region of the current video frame 132, to a location or position of the portion or region of the previous video frame 134 (e.g., reference video frame). The identified or selected portion or region of the previous video frame 134 can be used as a prediction for the current video frame 132. In embodiments, a difference between the portion or region of the current video frame 132 and the portion or region of the previous video frame 134 can be determined or computed and encoded, and can correspond to a prediction error. In embodiments, the frame predictor 112 can receive at a first input a current video frame 132 of a video 130, and at a second input a previous video frame 134 of the video 130. The previous video frame 134 can correspond to an adjacent video frame to the current video frame 132, with respect to a position within the video 130 or a video frame 134 that is positioned prior to the current video frame 132 with respect to a position within the video 130.

The frame predictor 112 can use the previous video frame 14 as a reference and determine similarities and/or differences between the previous video frame 134 and the current video frame 132. The frame predictor 112 can determine and apply a motion compensation to the current video frame 132 based in part on the previous video frame 134 and the similarities and/or differences between the previous video frame 134 and the current video frame 132. The frame predictor 112 can provide the motion compensated video 130 and/or video frame 132, 134, to a transform device 114.

The encoder 106 can include a transform device 114. The transform device 114 can include or be implemented in hardware, or at least a combination of hardware and software. For example, the transform device 114 can include a device, a circuit, software or a combination of a device, circuit and/or software to convert or transform video data (e.g., video 130, video frames 132, 134) from a spatial domain to a frequency (or other) domain. In embodiments, the transform device 114 can convert portions, regions or pixels of a video frame 132, 134 into a frequency domain representation. The transform device 114 can provide the frequency domain representation of the video 130 and/or video frame 132, 134 to a quantization device 116.

The encoder 106 can include a quantization device 116. The quantization device 116 can include or be implemented in hardware, or at least a combination of hardware and software. For example, the quantization device 116 can include a device, a circuit, software or a combination of a device, circuit and/or software to quantize the frequency representation of the video 130 and/or video frame 132, 134. In embodiments, the quantization device 116 can quantize or reduce a set of values corresponding to the video 130 and/or a video frame 132, 134 to a smaller or discrete set of values corresponding to the video 130 and/or a video frame 132, 134. The quantization device 116 can provide the quantized video data corresponding to the video 130 and/or a video frame 132, 134, to an inverse device 120 and a coding device 118.

The encoder 106 can include a coding device 118. The coding device 118 can include or be implemented in hardware, or at least a combination of hardware and software. For example, the coding device 118 can include a device, a circuit, software or a combination of a device, circuit and/or software to encode and compress the quantized video data. The coding device 118 can include, but not limited to, an entropy coding (EC) device to perform lossless or lossy compression. The coding device 118 can perform variable length coding or arithmetic coding. In embodiments, the coding device 118 can encode and compress the video data, including a video 130 and/or one or more video frames 132, 134 to generate a compressed video 138. The coding device 118 can provide the compressed video 138 corresponding to the video 130 and/or one or more video frames 132, 134, to a decoder 146 of a second device 140.

The encoder 106 can include a feedback loop to provide the quantized video data corresponding to the video 130 and/or video frame 132, 134 to the inverse device 120. The inverse device 120 can include or be implemented in hardware, or at least a combination of hardware and software. For example, the inverse device 120 can include a device, a circuit, software or a combination of a device, circuit and/or software to perform inverse operations of the transform device 114 and/or quantization device 116. The inverse device 120 can include a dequantization device, an inverse transform device or a combination of a dequantization device and an inverse transform device. For example, the inverse device 120 can receive the quantized video data corresponding to the video 130 and/or video frame 132, 134 to perform an inverse quantization on the quantized data through the dequantization device and perform an inverse frequency transformation through the inverse transform device to generate or produce a reconstructed video frame 132, 134. In embodiments, the reconstructed video frame 132, 134 can correspond to, be similar to or the same as a previous video frame 132, 134 provided to the transform device 114. The inverse device 120 can provide the reconstructed video frame 132, 134 to an input of the transform device 114 to be combined with or applied to a current or subsequent video frame 132, 134. The inverse device 120 can provide the reconstructed video frame 132, 134 to a prediction loop 136 of the first device 102.

The prediction loop 136 can include a lossy compression device 124 and a lossy decompression device 126. The prediction loop 136 can provide a previous video frame 134 of a video 130 to an input of the frame predictor 112 as a reference video frame for one or more current or subsequent video frames 132 provided to the frame predictor 112 and the encoder 106. In embodiments, the prediction loop 136 can receive a current video frame 132, perform lossy compression on the current video frame 132 and store the lossy compressed video frame 132 in a storage device 108 of the first device 102. The prediction loop 136 can retrieve a previous video frame 134 from the storage device 108, perform lossy decompression on the previous video frame 134, and provide the lossy decompressed previous video frame 134 to an input of the frame predictor 112.

The lossy compression device 124 can include or be implemented in hardware, or at least a combination of hardware and software. For example, the lossy compression device 124 can include a device, a circuit, software or a combination of a device, circuit and/or software to perform lossy compression on at least one video frame 132. In embodiments, the lossy compression can include at least one of a compression rate of the lossy compression, a loss factor, a quality metric or a sampling rate. The compression rate can correspond to a rate of compression used to compress a video frame 132 from a first size to a second size that is smaller or less than the first size. The compression rate can correspond to or include a reduction rate or reduction percentage to compress or reduce the video frame 132, 134. The loss factor can correspond to a determined amount of accepted loss in a size of a video frame 132, 134 to reduce the size of the video frame 132 from a first size to a second size that is smaller or less than the first size. The quality metric can correspond to a quality threshold or a desired level of quality of a video frame 132, 134 after the respective video frame 132, 134 has been lossy compressed. The sampling rate can correspond to a rate the samples, portions, pixels or regions of a video frame 132, 134 are acquired, processed and/or compressed during lossy compression. The lossy compression device 124 can generate a lossy compressed video frame 132 and provide or store the lossy compressed video frame 132 into the storage device 108 of the first device 102.

The lossy decompression device 126 can include or be implemented in hardware, or at least a combination of hardware and software. The lossy decompression device 126 can retrieve or receive a lossy compressed video frame 134 or a previous lossy compressed video frame 134 from the storage device 108 of the first device 102. The lossy decompression device 126 can include a device, a circuit, software or a combination of a device, circuit and/or software to perform lossy decompression or decompression on the lossy compressed video frame 134 or previous lossy compressed video frame 134 from the storage device 108. In embodiments, the lossy decompression can include or use at least one of a decompression rate of the lossy decompression, a quality metric or a sampling rate. The decompression rate can correspond to a rate of decompression used to decompress a video frame 132 from a second size to a first size that is greater than or larger than the second size. The decompression rate can correspond to or include a rate or percentage to decompress or increase a lossy compressed video frame 132, 134. The quality metric can correspond to a quality threshold or a desired level of quality of a video frame 132, 134 after the respective video frame 132, 134 has been decompressed. The sampling rate can correspond to a rate that the samples, portions, pixels or regions of a video frame 132, 134 are processed and/or decompressed during decompression. The lossy decompression device 126 can generate a lossy decompressed video frame 134 or a decompressed video frame 134 and provide the decompressed video frame 134 to at least one input of the frame predictor 112 and/or the encoder 106. In embodiments, the decompressed video frame 134 can correspond to a previous video frame 134 that is located or positioned prior to a current video frame 132 provided to the frame predictor 112 with respect to a location or position within the input video 130.

The storage device 108 can include or correspond to a frame buffer or memory buffer of the first device 102. The storage device 108 can be designed or implemented to store, hold or maintain any type or form of data associated with the first device 102, the encoder 106, the prediction loop 136, one or more input videos 130, and/or one or more video frames 132, 134. For example, the first device 102 and/or encoder 106 can store one or more lossy compressed video frames 132, 134, lossy compressed through the prediction loop 136, in the storage device 108. Use of the lossy compression can provide for a reduced size or smaller memory footprint or requirement for the storage device 108 and the first device 102. In embodiments, through lossy compression provided by the lossy compression device 124 of the prediction loop 136, the storage device 108 can be reduced by a range from 2 times to 16 times (e.g., 4 times to 8 times) in the size or memory footprint as compared to systems not using lossy compression. The storage device 108 can include a static random access memory (SRAM) or internal SRAM, internal to the first device 102. In embodiments, the storage device 108 can be included within an integrated circuit of the first device 102.

The storage device 108 can include a memory (e.g., memory, memory unit, storage device, etc.). The memory may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an example embodiment, the memory is communicably connected to the processor 104 via a processing circuit and includes computer code for executing (e.g., by the processing circuit and/or the processor) the one or more processes described herein.

The encoder 106 of the first device 102 can provide the compressed video 138 having one or more compressed video frames to a decoder 146 of the second device 140 for decoding and decompression. The receive device 140 (referred to herein as second device 140) can include a computing system or WiFi device. The second device 140 can include or correspond to a receiver in the video transmission system 100. In embodiments, the second device 140 can be implemented, for example, as a wearable computing device (e.g., smart watch, smart eyeglasses, head mounted display), smartphone, other mobile phone, device (e.g., consumer device), desktop computer, laptop computer, a VR puck, a VR PC, VR computing device, a head mounted device or implemented with distributed computing devices. The second device 140 can be implemented to provide a virtual reality (VR), augmented reality (AR), and/or mixed reality (MR) experience. In some embodiments, the second device 140 can include conventional, specialized or custom computer components such as processors 104, a storage device 160, a network interface, a user input device, and/or a user output device.

The second device 140 can include one or more processors 104. The one or more processors 104 can include any logic, circuitry and/or processing component (e.g., a microprocessor) for pre-processing input data (e.g., compressed video 138, video frames 172, 174) for the second device 140, decoder 146 and/or reference loop 154, and/or for post-processing output data for the second device 140, decoder 146 and/or reference loop 154. The one or more processors 104 can provide logic, circuitry, processing component and/or functionality for configuring, controlling and/or managing one or more operations of the second device 140, decoder 146 and/or reference loop 154. For instance, a processor 104 may receive data associated with a compressed video 138 and/or video frame 172, 174 to decode and decompress the compressed video 138 and/or the video frame 172, 174 to generate a decompressed video 170.

The second device 140 can include a decoder 146. The decoder 146 can include or be implemented in hardware, or at least a combination of hardware and software. For example, the decoder 146 can include a device, a circuit, software or a combination of a device, circuit and/or software to convert data (e.g., video 130, video frames 132, 134) from one format to a second different format (e.g., from encoded to decoded). In embodiments, the decoder 146 can decode and/or decompress a compressed video 138 and/or one or more video frames 172, 174 to generate a decompressed video 170.

The decoder 146 can include a decoding device 148. The decoding device 148 can include, but not limited to, an entropy decoder. The decoding device 148 can include or be implemented in hardware, or at least a combination of hardware and software. For example, the decoding device 148 can include a device, a circuit, software or a combination of a device, circuit and/or software to decode and decompress a received compressed video 138 and/or one or more video frames 172, 174 corresponding to the compressed video 138. The decoding device 148 can (operate with other components to) perform pre-decoding, and/or lossless or lossy decompression. The decoding device 148 can perform variable length decoding or arithmetic decoding. In embodiments, the decoding device 148 can (operate with other components to) decode the compressed video 138 and/or one or more video frames 172, 174 to generate a decoded video and provide the decoded video to an inverse device 150.

The inverse device 150 can include or be implemented in hardware, or at least a combination of hardware and software. For example, the inverse device 150 can include a device, a circuit, software or a combination of a device, circuit and/or software to perform inverse operations of a transform device and/or quantization device. In embodiments, the inverse device 150 can include a dequantization device, an inverse transform device or a combination of a dequantization device and an inverse transform device. For example, the inverse device 120 can receive the decoded video data corresponding to the compressed video 138 to perform an inverse quantization on the decoded video data through the dequantization device. The dequantization device can provide the de-quantized video data to the inverse transform device to perform an inverse frequency transformation on the de-quantized video data to generate or produce a reconstructed video frame 172, 174. The reconstructed video frame 172, 174 can be provided to an input of an adder of the decoder 146.

The adder 152 can receive the reconstructed video frame 172, 174 at a first input and a previous video frame 174 (e.g., decompressed previous video frame) from a storage device 160 of the second device 140 through a reference loop 154 at a second input. The adder 152 can combine or apply the previous video frame 174 to the reconstructed video frame 172, 174 to generate a decompressed video 170. The adder 152 can include or be implemented in hardware, or at least a combination of hardware and software. For example, the adder 152 can include a device, a circuit, software or a combination of a device, circuit and/or software to combine or apply the previous video frame 174 to the reconstructed video frame 172, 174.

The second device 140 can include a feedback loop or feedback circuitry having a reference loop 154. For example, the reference loop 154 can receive one or more decompressed video frames associated with or corresponding to the decompressed video 170 from the adder 152 and the decoder 146. The reference loop 154 can include a lossy compression device 156 and a lossy decompression device 158. The reference loop 154 can provide a previous video frame 174 to an input of the adder 152 as a reference video frame for one or more current or subsequent video frames 172 decoded and decompressed by the decoder 146 and provided to the adder 152. In embodiments, the reference loop 154 can receive a current video frame 172 corresponding to the decompressed video 170, perform lossy compression on the current video frame 172 and store the lossy compressed video frame 172 in a storage device 160 of the second device 140. The reference loop 154 can retrieve a previous video frame 174 from the storage device 160, perform lossy decompression or decompression on the previous video frame 174 and provide the decompressed previous video frame 174 to an input of the adder 152.

The lossy compression device 156 can include or be implemented in hardware, or at least a combination of hardware and software. For example, the lossy compression device 156 can include a device, a circuit, software or a combination of a device, circuit and/or software to perform lossy compression on at least one video frame 172. In embodiments, the lossy compression can be performed using at least one of a compression rate of the lossy compression, a loss factor, a quality metric or a sampling rate. The compression rate can correspond to a rate of compression used to compress a video frame 172 from a first size to a second size that is smaller or less than the first size. The compression rate can correspond to or include a reduction rate or reduction percentage to compress or reduce the video frame 172, 174. The loss factor can correspond to a determined amount of accepted loss in a size of a video frame 172, 174 to reduce the size of the video frame 172 from a first size to a second size that is smaller or less than the first size. In embodiments, the second device 140 can select the loss factor of the lossy compression using the quality metric or a desired quality metric for a decompressed video 170. The quality metric can correspond to a quality threshold or a desired level of quality of a video frame 172, 174 after the respective video frame 172, 174 has been lossy compressed. The sampling rate can correspond to a rate that the samples, portions, pixels or regions of a video frame 172, 174 are processed and/or compressed during lossy compression. The lossy compression device 156 can generate a lossy compressed video frame 172, and can provide or store the lossy compressed video frame 172 into the storage device 160 of the second device 140.

The lossy decompression device 158 can include or be implemented in hardware, or at least a combination of hardware and software. The lossy decompression device 158 can retrieve or receive a lossy compressed video frame 174 or a previous lossy compressed video frame 174 from the storage device 160 of the second device 140. The lossy decompression device 158 can include a device, a circuit, software or a combination of a device, circuit and/or software to perform lossy decompression or decompression on the lossy compressed video frame 174 or previous lossy compressed video frame 174 from the storage device 160. In embodiments, the lossy decompression can include at least one of a decompression rate of the lossy decompression, a quality metric or a sampling rate. The decompression rate can correspond to a rate of decompression used to decompress a video frame 174 from a second size to a first size that is greater than or larger than the second size. The decompression rate can correspond to or include a rate or percentage to decompress or increase a lossy compressed video frame 172, 174. The quality metric can correspond to a quality threshold or a desired level of quality of a video frame 172, 174 after the respective video frame 172, 174 has been decompressed. The sampling rate can correspond to a rate the samples, portions, pixels or regions of a video frame 172, 174 are processed and/or decompressed during decompression. The lossy decompression device 158 can generate a lossy decompressed video frame 174 or a decompressed video frame 174 and provide the decompressed video frame 174 to at least one input of the adder 152 and/or the decoder 146. In embodiments, the decompressed video frame 174 can correspond to a previous video frame 174 that is located or positioned prior to a current video frame 172 of the decompressed video 170 with respect to a location or position within the decompressed video 170.

The storage device 160 can include or correspond to a frame buffer or memory buffer of the second device 140. The storage device 160 can be designed or implemented to store, hold or maintain any type or form of data associated with the second device 140, the decoder 146, the reference loop 154, one or more decompressed videos 170, and/or one or more video frames 172, 174. For example, the second device 140 and/or decoder 146 can store one or more lossy compressed video frames 172, 174, lossy compressed through the reference loop 154, in the storage device 160. The lossy compression can provide for a reduced size or smaller memory footprint or requirement for the storage device 160 and the second device 140. In embodiments, through lossy compression provided by the lossy compression device 156 of the reference loop 154, the storage device 160 can be reduced by an amount in a range from 4 times to 8 times the size or memory footprint as compared to systems not using lossy compression. The storage device 160 can include a static random access memory (SRAM) or internal SRAM, internal to the second device 140. In embodiments, the storage device 160 can be included within an integrated circuit of the second device 140.

The storage device 160 can include a memory (e.g., memory, memory unit, storage device, etc.). The memory may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an example embodiment, the memory is communicably connected to the processor(s) 104 via a processing circuit and includes computer code for executing (e.g., by the processing circuit and/or the processor(s)) the one or more processes described herein.

The first device 102 and the second device 140 can be connected through one or more transmission channels 180, for example, for the first device 102 to provide one or more compressed videos 138, one or more compressed video frames 172, 174, encoded video data, and/or configuration (e.g., compression rate) of a lossy compression to the second device 140. The transmission channels 180 can include a channel, connection or session (e.g., wireless or wired) between the first device 102 and the second device 140. In some embodiments, the transmission channels 180 can include encrypted and/or secure connections 180 between the first device 102 and the second device 140. For example, the transmission channels 180 may include encrypted sessions and/or secure sessions established between the first device 102 and the second device 140. The encrypted transmission channels 180 can include encrypted files, data and/or traffic transmitted between the first device 102 and the second device 140.

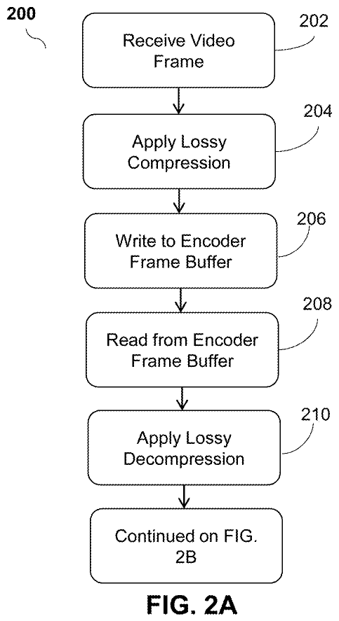

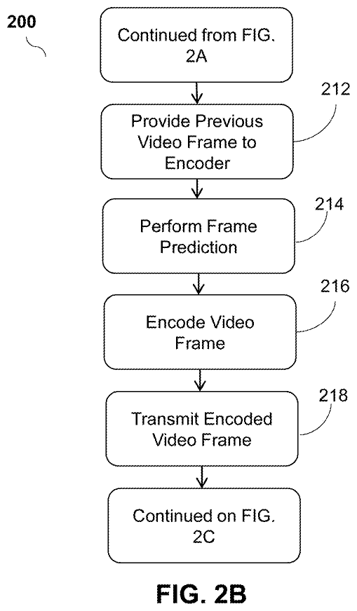

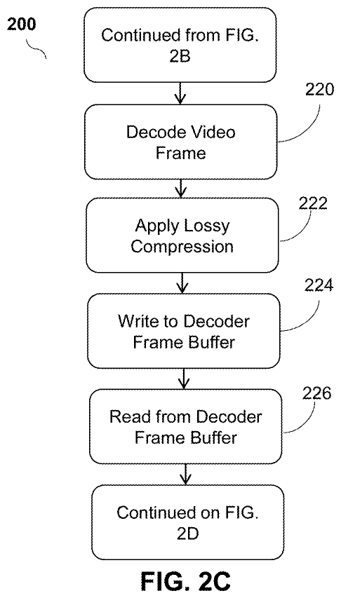

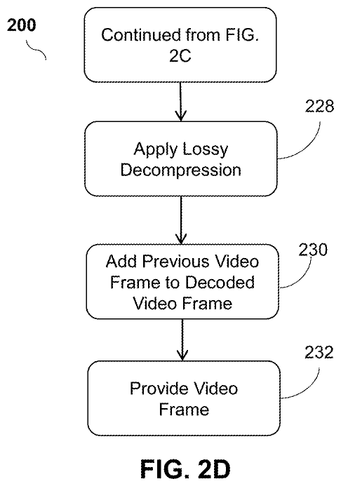

Now referring to FIGS. 2A-2D, a method 200 for reducing a size and power consumption in encoder and decoder frame buffers using lossy compression is depicted. In brief overview, the method 200 can include one or more of: receiving a video frame (202), applying lossy compression (204), writing to an encoder frame buffer (206), reading from the encoder frame buffer (208), applying lossy decompression (210), providing a previous video frame to the encoder (212), performing frame prediction (214), encoding the video frame (216), transmitting the encoded video frame (218), decoding the video frame (220), applying lossy compression (222), writing to a decoder frame buffer (224), reading from the decoder frame buffer (226), applying lossy decompression (228), adding a previous video frame to the decoded video frame (230), and providing a video frame (232). Any of the foregoing operations may be performed by any one or more of the components or devices described herein, for example, the first device 102, the second device 140, the encoder 106, the prediction loop 136, the reference loop 154, the decoder 146 and the processor(s) 104.

Referring to 202, and in some embodiments, an input video 130 can be received. One or more input videos 130 can be received at a first device 102 of a video transmission system 100. The video 130 can include or be made up of a plurality of video frames 132. The first device 102 can include or correspond to a transmit device of the video transmission system 100, can receive the video 130, encode and compress the video frames 132 forming the video 130 and can transmit the compressed video 138 (e.g., compressed video frames 132) to a second device 140 corresponding to a receive device of the video transmission system 100.

The first device 102 can receive the plurality of video frames 132 of the video 130. In embodiments, the first device 102 can receive the video 130 and can partition the video 130 into a plurality of video frames 132, or identify the plurality of video frames 132 forming the video 130. The first device 102 can partition the video 130 into video frames 132 of equal size or length. For example, each of the video frames 132 can be the same size or the same length in terms of time. In embodiments, the first device 102 can partition the video frames 132 into one or more different sized video frames 132. For example, one or more of the video frames 132 can have a different size or different time length as compared to one or more other video frames 132 of the video 130. The video frames 132 can correspond to individual segments or individual portions of the video 130. The number of video frames 132 of the video 130 can vary and can be based at least in part on an overall size or overall length of the video 130. The video frames 132 can be provided to an encoder 106 of the first device 102. The encoder 106 can include a frame predictor 112, and the video frames 132 can be provided to or received at a first input of the frame predictor 112. The encoder 106 of the first device 102 can provide a first video frame for encoding to a prediction loop 136 for the frame predictor 112 of the first device 102.

Referring to 204, and in some embodiments, lossy compression can be applied to a video frame 132. Lossy compression can be applied, in the prediction loop 136, to the first video frame 132 to generate a first compressed video frame 132. In embodiments, the prediction loop 136 can receive the first video frame 132 from an output of the inverse device 120. For example, the first video frame 132 provided to the prediction loop 136 can include or correspond to an encoded video frame 132 or processed video frame 132. The prediction loop 136 can include a lossy compression device 124 configured to apply lossy compression to one or more video frames 132. The lossy compression device 124 can apply lossy compression to the first video frame 132 to reduce a size or length of the first video frame 132 from a first size to a second size such that the second size or compressed size is less than the first size.

The lossy compression can include a configuration or properties to reduce or compress the first video frame 132. In embodiments, the configuration of the lossy compression can include, but is not limited to, a compression rate of the lossy compression, a loss factor, a quality metric or a sampling rate. The lossy compression device 124 can apply lossy compression having a selected or determined compression rate to reduce or compress the first video frame 132 from the first size to the second, smaller size. The selected compression rate can be selected based in part on an amount of reduction of the video frame 132 and/or a desired compressed size of the video frame 132. The lossy compression device 124 can apply lossy compression having a loss factor that is selected based in part on an allowable or selected amount of loss of the video frame 132 when compressing the video frame 132. In embodiments, the loss factor can correspond to an allowable amount of loss between an original version or pre-compressed version of a video frame 132 to compressed video frame 132. In embodiments, the first device 102 can select or determine the loss factor of the lossy compression using the quality metric for a decompressed video 170 to be generated by the second device 140.

The lossy compression device 124 can apply lossy compression having a quality metric that is selected based in part on an allowable or desired quality level of a compressed video frame 132. For example, the lossy compression device 124 can apply lossy compression having a first quality metric to generate compressed video frames 132 having a first quality level or high quality level, and apply lossy compression having a second quality metric to generate compressed video frames 132 having a second quality level or low quality level (that is lower in quality than the high quality level). The lossy compression device 124 can apply lossy compression having a determined sampling rate corresponding to a rate that the samples, portions, pixels or regions of the video frame 132 are processed and/or compressed during lossy compression. The sampling rate can be selected based in part on the compression rate, the loss factor, the quality metric or any combination of the compression rate, the loss factor, and the quality metric. The lossy compression device 124 can apply lossy compression to the first video frame 132 to generate a lossy compressed video frame 132 or compressed video frame 132.

Referring to 206, and in some embodiments, a lossy compressed video frame 132 can be written to an encoder frame buffer 108. The first device 102 can write or store the compressed video frame 132 to a storage device 108 of the first device 102. The storage device 108 can include or correspond to an encoder frame buffer. For example, the storage device 108 can include a static random access memory (SRAM) in the first device 102. For example, the storage device 108 can include an internal SRAM, internal to the first device 102. In embodiments, the storage device 108 can be included within an integrated circuit of the first device 102. The first device 102 can store the first compressed video frame 132 in the storage device 108 in the first device 102 (e.g., at the first device 102, as a component of the first device 102) instead of or rather than in a storage device external to the first device 102. For example, the first device 102 can store the first compressed video frame 132 in the SRAM 108 in the first device 102, instead of or rather than in a dynamic random access memory (DRAM) external to the first device 102. The storage device 108 can be connected to the prediction loop 136 to receive one or more compressed video frames 132 of a received video 130. The first device 102 can write or store the compressed video frame 132 to at least one entry of the storage device 108. The storage device 108 can include a plurality of entries or locations for storing one or more videos 130 and/or a plurality of video frames 132, 134 corresponding to the one or more videos 130. The entries or locations of the storage device 108 can be organized based in part on a received video 130, an order of a plurality of video frames 132 and/or an order the video frames 132 are written to the storage device 108.

The lossy compression used to compress the video frames 132 can provide for a reduced size or smaller memory footprint for the storage device 108. The first device 102 can store compressed video frames 132 compressed to a determined size through the prediction loop 136 to reduce a size of the storage device 108 by a determined percentage or amount (e.g., 4× reduction, 8× reduction) that corresponds to or is associated with the compression rate of the lossy compression. In embodiments, the first device 102 can store compressed video frames 132 compressed to a determined size through the prediction loop 136, to reduce the size or memory requirement used for the storage device 108 from a first size to a second, smaller size.

Referring to 208, and in some embodiments, a previous lossy compressed video frame 134 can be read from the encoder frame buffer 108. The first device 102 can read or retrieve a previous compressed video frame 134 (e.g., frame (N−1)) from the storage device 108 through the prediction loop 136. The previous compressed video frame 134 can include or correspond to a reference video frame 132. The first device 102 can identify at least one video frame 134 that is prior to or positioned before a current video frame 132 received at the first device 102 and/or encoder 106. The first device 102 can select the previous video frame 134 based in part on a current video frame 132 received at the encoder 106. For example, the previous video frame 134 can include or correspond to a video frame that is positioned or located before or prior to the current video frame 132 in the video 130. The current video frame 132 can include or correspond to a subsequent or adjacent video frame in the video 130 with respect to a position or location amongst the plurality of video frames 132, 134 forming the video 130. The first device 102 can read the previous video frame 134 to be used as a reference video frame or to generate a reference signal to compare with or determine properties of one or more current or subsequent video frames 132 received at the encoder 106.

Referring to 210, and in some embodiments, lossy decompression can be applied to a previous video frame 134. The first device 102 can apply, in the prediction loop 136, lossy decompression to the first compressed video frame 134 or previous compressed video frame read from the storage device 108. The first device 102 can read the first compressed video frame 134, now a previous video frame 134 as already having been received and processed at the encoder 106, and apply decompression to the previous video frame 134 (e.g., first video frame). The prediction loop 136 can include a lossy decompression device 126 to apply or provide lossy decompression (or simply decompression) to decompress or restore a compressed video frame 134 to a previous or original form, for example, prior to being compressed. The lossy decompression device 126 can apply decompression to the previous video frame 134 to increase or restore a size or length of the previous video frame 132 from the second or compressed size to the first, uncompressed or original size such that the first size is greater than or larger than the second size.

The lossy decompression can include a configuration or properties to decompress, restore or increase a size of the previous video frame 134. In embodiments, the configuration of the lossy decompression can include, but is not limited to, a decompression rate of the lossy decompression, a loss factor, a quality metric or a sampling rate. The lossy decompression device 126 can apply decompression having a selected or determined decompression rate to decompress, restore or increase the previous video frame 134 from the second, compressed size to the first, restored or original size. The selected decompression rate can be selected based in part on a compression rate of the lossy compression performed on the previous video frame 134. The selected decompression rate can be selected based in part on an amount of decompression of the previous video frame 134 to restore the size of the previous video frame 134. The lossy decompression device 126 can apply decompression corresponding to the loss factor used to compress the previous video frame 134 to restore the previous video frame 134. In embodiments, the loss factor can correspond to an allowable amount of loss between an original version or pre-compressed version of the previous video frame 134 to a restored or decompressed previous video frame 134.

The lossy decompression device 126 can apply decompression having a quality metric that is selected based in part on an allowable or desired quality level of a decompressed previous video frame 134. For example, the lossy decompression device 126 can apply decompression having a first quality metric to generate decompressed previous video frames 134 having a first quality level or high quality level, and apply decompression having a second quality metric to generate decompressed previous video frames 134 having a second quality level or low quality level (that is lower in quality than the high quality level). The lossy decompression device 126 can apply decompression having a determined sampling rate corresponding to a rate at which the samples, portions, pixels or regions of the video frame 132 are processed and/or compressed during lossy compression. The sampling rate can be selected based in part on the decompression rate, the loss factor, the quality metric or any combination of the decompression rate, the loss factor, and the quality metric. The lossy decompression device 126 can apply decompression to the previous video frame 134 to generate a decompressed video frame 134.

Referring to 212, and in some embodiments, a previous video frame 134 can be provided to an encoder 106. The first device 102, through the prediction loop 136, can provide the decompressed previous video frame 134 to the encoder 106 to be used in a motion estimation with a current or subsequent video frame 132, subsequent to the previous video frame 134 with respect to a position or location within the video 130. In some embodiments, the prediction loop 136 can correspond to a feedback loop to lossy compress one or more video frames 132, write the lossy compressed video frames 132 to the storage device 108, read one or more previous compressed video frames 134, decompress the previous video frames 134 and provide the decompressed previous video frames 134 to the encoder 106. The first device 102 can provide the previous video frames 134 to the encoder 106 to be used as reference video frames for a current or subsequent video frame 132 received at the encoder 106 and to determine properties of the current or subsequent video frame 132 received at the encoder 106.

Referring to 214, and in some embodiments, frame prediction can be performed. In embodiments, the encoder 106 can receive a second video frame 132 subsequent to the first video frame 132 (e.g., previous video frame 134) and receive, from the prediction loop 136, a decompressed video frame 134 generated by applying the lossy decompression to the first video frame 132. The decompressed video frame 134 can include or correspond to a reference video frame 134 or reconstructed previous video frame 134 (e.g., reconstructed first video frame 134). A frame predictor 112 can estimate a motion metric according to the second video frame 132 and the decompressed video frame 134. The motion metric can include, but not limited to, a motion compensation to be applied to a current or subsequent video frame 132, 134 based in part on the motion properties of or relative to a previous video frame 134. For example, the frame predictor 112 can determine or detect a motion metric between video frames 132, 134 (e.g., successive video frames, adjacent video frames) of a video 130 to provide motion compensation to one or more current or subsequent video frames 132 of a video 130 based on one or more previous video frames 134 of the video 130. The frame predictor 112 can generate a motion metric that includes a motion vector including offsets (e.g., horizontal offsets, vertical offsets) corresponding to a location or position of the portion or region of the current video frame 132, to a location or position of the portion or region of the previous video frame 134 (e.g., reference video frame). The frame predictor 112 can apply the motion metric to a current or subsequent video frame 132. For example, to reduce or eliminate redundant information to be transmitted, the encoder 106 can predict the current video frame 132 based in part on a previous video frame 132. The encoder 106 can calculate an error (e.g., residual) of the predicted video frame 132 versus or in comparison to the current video frame 132 and then encode and transmit the motion metric (e.g., motion vectors) and residuals instead of an actual video frame 132 and/or video 130.

Referring to 216, and in some embodiments, the video frame 132, 134 can be encoded. In embodiments, the encoder 106 can encode, through the transform device 114, quantization device 116 and/or coding device 118, the first video frame 132 using data from one or more previous video frames 134, to generate or provide the encoded video data corresponding to the video 130 and one or more video frames 132 forming the video 130. For example, the transform device 114 can receive the first video frame 132, and can convert or transform the first video frame 132 (e.g., video 130, video data) from a spatial domain to a frequency domain. The transform device 114 can convert portions, regions or pixels of the video frame 132 into a frequency domain representation. The transform device 114 can provide the frequency domain representation of the video frame 132 to quantization device 116. The quantization device 116 can quantize the frequency representation of the video frame 132 or reduce a set of values corresponding to the video frame 132 to a smaller or discrete set of values corresponding to the video frame 132.

The quantization device 116 can provide the quantized video frame 132 to an inverse device 120 of the encoder 106. In embodiments, the inverse device 120 can perform inverse operations of the transform device 114 and/or quantization device 116. For example, the inverse device 120 can include a dequantization device, an inverse transform device or a combination of a dequantization device and an inverse transform device. The inverse device 120 can receive the quantized video frame 132 and perform an inverse quantization on the quantized data through the dequantization device and perform an inverse frequency transformation through the inverse transform device to generate or produce a reconstructed video frame 132. In embodiments, the reconstructed video frame 132 can correspond to, be similar to or the same as a previous video frame 132 provided to the transform device 114. The inverse device 120 can provide the reconstructed video frame 132 to an input of the transform device 114 to be combined with or applied to a current or subsequent video frame 132. The inverse device 120 can provide the reconstructed video frame 132 to the prediction loop 136 of the first device 102.

The quantization device 116 can provide the quantized video frame 132 to a coding device 118 of the encoder 106. The coding device 118 can encode and/or compress the quantized video frame 132 to generate a compressed video 138 and/or compressed video frame 132. In embodiments, the coding device 118 can include, but not limited to, an entropy coding (EC) device to perform lossless or lossy compression. The coding device 118 can perform variable length coding or arithmetic coding. In embodiments, the coding device 118 can encode and compress the video data, including a video 130 and/or one or more video frames 132, 134 to generate the compressed video 138.

Referring to 218, and in some embodiments, the encoded video frame 132, 134 can be transmitted from a first device 102 to a second device 140. The encoder 106 of the first device 102 can provide, to a decoder 146 of the second device 140 to perform decoding, encoded video data corresponding to the first video frame 132, and a configuration of the lossy compression. The encoder 106 of the first device 102 can transmit the encoded video data corresponding to the video 130 and one or more video frames 132 forming the video 130 to a decoder 146 of the second device 140. The encoder 106 can transmit the encoded video data, through one or more transmission channels 180 connecting the first device 102 to the second device 140, to the decoder 146.

In embodiments, the encoder 106 and/or the first device 102 can provide the configuration of the lossy compression performed through the prediction loop 136 of the first device 102 to the decoder 146 of the second device 140. The encoder 106 and/or the first device 102 can provide the configuration of the lossy compression to cause or instruct the decoder 146 of the second device 140 to perform decoding of the encoded video data (e.g., compressed video 138, compressed video frames 132) using the configuration of the lossy compression (and lossy decompression) performed by the first device 102 through the prediction loop 136. In embodiments, the first device 102 can cause or instruct the second device 140 to apply lossy compression in the reference loop 154 of the second device 140, according to or based upon the configuration of the lossy compression (and lossy decompression) performed by the first device 102 through the prediction loop 136.

The encoder 106 and/or the first device 102 can provide the configuration of the lossy compression in at least one of: subband metadata, a header of a video frame transmitted from the encoder to the decoder, or in a handshake message for establishing a transmission channel between the encoder and the decoder. The configuration of the lossy compression (and lossy decompression) can include, but is not limited to, a compression rate of the lossy compression, a decompression rate of the lossy decompression, a loss factor, a quality metric or a sampling rate. In embodiments, the encoder 106 and/or first device 102 can embed or include the configuration in metadata, such as subband metadata, that is transmitted between the first device 102 and the second device 140 through one or more transmission channels 180. For example, the encoder 106 and/or first device 102 can generate metadata having the configuration for the lossy compression and can embed the metadata in message(s) transmitted in one or more bands (e.g., frequency bands) or subdivision of bands and provide the subband metadata to the second device 140 through one or more transmission channels 180.

In embodiments, the encoder 106 and/or first device 102 can include or embed the configuration of the lossy compression (and lossy decompression) into a header of a video frame 132 or header of a compressed video 138 prior to transmission of the respective video frame 132 or compressed video 138 to the second device 140. In embodiments, the encoder 106 and/or first device 102 can include or embed the configuration of the lossy compression (and lossy decompression) in a message, command, instruction or a handshake message for establishing a transmission channel 180 between the encoder 106 and the decoder 146 and/or between the first device 102 and the second device 140. For example, the encoder 106 and/or first device 102 can generate a message, command, instruction or a handshake message to establish a transmission channel 180, and can include the configuration of the lossy compression (and lossy compression) within the message, command, instruction or the handshake message, and can transmit the message, command, instruction or the handshake message to decoder 146 and/or second device 140.

Referring to 220, and in some embodiments, the video frame 172 can be decoded. The decoder 146 of the second device 140 can decode the encoded video data to generate a decoded video frame 172. For example, the decoder 146 can receive encoded video data that includes or corresponds to the compressed video 138. The compressed video 138 can include one or more encoded and compressed video frames 172 forming the compressed video 138. The decoder 146 and decode and decompress the encoded and compressed video frames 172 through a decoding device 148 and inverse device 150 of the decoder 146, to generate a decoded video frame 172. The decoder 146 and/or the second device 140 can combine, using a reference loop 154 of the second device 140 and an adder 152 of the decoder 146, the decoded video frame 172 and a previous decoded video frame 174 provided by the reference loop 154 of the decoder or the second device 140 to generate a decompressed video 170 and/or decompressed video frames 172 associated with the first video frame 132 and/or the input video 130 received at the first device 102 and/or the encoder 106.

For example, the encoded video data including the compressed video 138 can be received at or provided to a decoding device 148 of the decoder 146. In embodiments, the decoding device 148 can include or correspond to an entropy decoding device and can perform lossless compression or lossy compression on the encoded video data. The decoding device 148 can decode the encoded data using, but not limited to, variable length decoding or arithmetic decoding to generate decoded video data that includes one or more decoded video frames 172. The decoding device 148 can be connected to and provide the decoded video data that includes one or more decoded video frames 172 to the inverse device 150 of the decoder 146.

The inverse device 150 can perform inverse operations of a transform device and/or quantization device on the decoded video frames 172. For example, the inverse device 150 can include or perform the functionality of a dequantization device, an inverse transform device or a combination of a dequantization device and an inverse transform device. In some embodiments, the inverse device 150 can, through the dequantization device, perform an inverse quantization on the decoded video frames 172. The inverse device 150 can, through the inverse transform device, perform an inverse frequency transformation on the de-quantized video frames 172 to generate or produce a reconstructed video frame 172, 174. The reconstructed video frame 172, 174 can be provided to an input of an adder of the decoder 146. In embodiments, the adder 152 can combine or apply a previous video frame 174 to the reconstructed video frame 172, 174 to generate a decompressed video 170. The previous video frame 174 can be provided to the adder 152 by the second device 140 through the reference loop 154. In embodiments, the adder 152 can receive the reconstructed video frame 172, 174 at a first input and a previous video frame 174 (e.g., decompressed previous video frame) from a storage device 160 of the second device 140 through a reference loop 154 at a second input.

Referring to 222, and in some embodiments, lossy compression can be applied to a video frame 172. The second device 140 can apply, through the reference loop 154, lossy compression to a decoded video frame 172. For example, the second device 140 can provide an output of the adder 152 corresponding to a decoded video frame 172, to the reference loop 154, and the reference loop 154 can include a lossy compression device 156. The lossy compression device 156 can apply lossy compression to the decoded video frame 172 to reduce a size or length of the decoded video frame 172 from a first size to a second size such that the second size or compressed size is less than the first size. The lossy compression device 156 of the reference loop 154 of the second device 140 can use the same or similar configuration or properties for lossy compression as the lossy compression device 124 of the prediction loop 136 of the first device 102. In embodiments, the first device 102 and the second device 140 can synchronize or configure the lossy compression applied in the prediction loop 136 of the first device 102 and lossy compression applied by a reference loop 154 of the second device 140 to have a same compression rate, loss factor, and/or quality metric. In embodiments, the first device 102 and the second device 140 can synchronize or configure the lossy compression applied in the prediction loop 136 of the first device 102 and lossy compression applied by a reference loop 154 of the second device 140 to provide bit-identical results. For example, in embodiments, the lossy compression applied in the prediction loop 136 of the first device 102 and lossy compression applied by a reference loop 154 of the second device 140 can be the same or perfectly matched to provide the same results.

The lossy compression device 156 can apply lossy compression having a selected or determined compression rate to reduce or compress the decoded video frame 172 from the first size to the second, smaller size. The selected compression rate can be selected based in part on an amount of reduction of the decoded video frame 172 and/or a desired compressed size of the decoded video frame 172. The lossy compression device 156 can apply lossy compression having a loss factor that is selected based in part on an allowable or selected amount of loss of the decoded video frame 172 when compressing the decoded video frame 172. In embodiments, the loss factor can correspond to an allowable amount of loss between an original version or pre-compressed version of the decoded video frame 172 to compressed video frame 172.

The lossy compression device 156 can apply lossy compression having a quality metric that is selected based in part on an allowable or desired quality level of a compressed video frame 172. The lossy compression device 156 can apply lossy compression having a first quality metric to generate a compressed video frame 172 having a first quality level or high quality level and apply lossy compression having a second quality metric to generate a compressed video frame 172 having a second quality level or low quality level (that is lower in quality then the high quality level). The lossy compression device 156 can apply lossy compression having a determined sampling rate corresponding to a rate the samples, portions, pixels or regions of the decoded video frame 172 are processed and/or compressed during lossy compression. The sampling rate can be selected based in part on the compression rate, the loss factor, the quality metric or any combination of the compression rate, the loss factor, and the quality metric. The lossy compression device 156 can apply lossy compression to the decoded video frame 172 from the decoder 146 to generate a lossy compressed video frame 172 or compressed video frame 172.

Referring to 224, and in some embodiments, the video frame 172 can be written to a decoder frame buffer 160. The second device 140, through the reference loop 154, can write or store the compressed video frame 172 to a decoder frame buffer or storage device 160 of the second device 140. The storage device 160 can include a static random access memory (SRAM) in the second device 140. In embodiments, the storage device 160 can include an internal SRAM, internal to the second device 140. The storage device 160 can be included within an integrated circuit of the second device 140. The second device 140 can store the compressed video frame 172 in the storage device 160 in the second device 140 (e.g., at the second device 140, as a component of the second device 140) instead of or rather than in a storage device external to the second device 140. For example, the second device 140 can store the compressed video frame 172 in the SRAM 160 in the second device 140, instead of or rather than in a dynamic random access memory (DRAM) external to the second device 140. The storage device 160 can be connected to the reference loop 154 to receive one or more compressed video frames 174 corresponding to the decoded video data from the decoder 146. The second device 140 can write or store the compressed video frame 172 to at least one entry of the storage device 160. The storage device 160 can include a plurality of entries or locations for storing one or more compressed videos 138 and/or a plurality of video frames 172, 174 corresponding to the one or more compressed videos 138. The entries or locations of the storage device 160 can be organized based in part on the compressed video 138, an order of a plurality of video frames 172 and/or an order the video frames 172 are written to the storage device 160.

Referring to 226, and in some embodiments, a previous video frame 174 can be read from the decoder frame buffer 160. The second device 140 can read or retrieve a previous compressed video frame 174 (e.g., frame (N−1)) from the storage device 160 through the reference loop 154. The second device 140 can identify at least one video frame 174 that is prior to or positioned before a current decoded video frame 172 output by the decoder 146. The second device 140 can select the previous video frame 174 based in part on a current decoded video frame 172. For example, the previous video frame 174 can include or correspond to a video frame that is positioned or located before or prior to the current decoded video frame 172 in a decompressed video 170 and/or compressed video 138. The current decoded video frame 172 can include or correspond to a subsequent or adjacent video frame in the decompressed video 170 and/or compressed video 138 with respect to a position or location amongst the plurality of video frames 172, 174 forming the decompressed video 170 and/or compressed video 138. The second device 140 can read the previous video frame 174 to be used as a reference video frame or to generate a reference signal to compare with or determine properties of one or more current or subsequent decoded video frames 172 generated by the decoder 146.

Referring to 228, and in some embodiments, lossy decompression can be applied to a previous video frame 174. The second device 140 can apply, in the reference loop 154, lossy decompression to the previous compressed video frame 174 read from the storage device 160. The reference loop 154 can include a lossy decompression device 158 to apply or provide lossy decompression (or simply decompression) to decompress or restore a previous compressed video frame 174 to a previous or original form, for example, prior to being compressed. The lossy decompression device 158 can apply decompression to the previous video frame 174 to increase or restore a size or length of the previous video frame 174 from the second or compressed size to the first, uncompressed or original size such that the first size is greater than or larger than the second size. The lossy decompression can include a configuration or properties to decompress, restore or increase a size of the previous video frame 174. In embodiments, the configuration of the lossy decompression can include, but is not limited to, a decompression rate of the lossy decompression, a loss factor, a quality metric or a sampling rate. The configuration of the lossy decompression can be the same as or derived from the compression/decompression configuration of the prediction loop of the first device 102. The lossy decompression device 158 of the reference loop 154 of the second device 140 can use the same or similar configuration or properties for decompression as the lossy decompression device 126 of the prediction loop 136 of the first device 102. In embodiments, the first device 102 and the second device 140 can synchronize or configure the decompression applied in the prediction loop 136 of the first device 102 and the decompression applied by a reference loop 154 of the second device 140, to have a same decompression rate, loss factor, and/or quality metric.

The lossy decompression device 158 can apply decompression having a selected or determined decompression rate to decompress, restore or increase the previous video frame 174 from the second, compressed size to the first, restored or original size. The selected decompression rate can be selected based in part on a compression rate of the lossy compression performed on the previous video frame 174. The selected decompression rate can be selected based in part on an amount of decompression of the previous video frame 174 to restore the size of the previous video frame 174. The lossy decompression device 158 can apply decompression corresponding to the loss factor used to compress the previous video frame 174 to restore the previous video frame 174. In embodiments, the loss factor can correspond to an allowable amount of loss between an original version or pre-compressed version of the previous video frame 174 to a restored or decompressed previous video frame 174.

The lossy decompression device 158 can apply decompression having a quality metric that is selected based in part on an allowable or desired quality level of a decompressed previous video frame 174. For example, the lossy decompression device 158 can apply decompression having a first quality metric to generate decompressed previous video frames 174 having a first quality level or high quality level and apply decompression having a second quality metric to generate decompressed previous video frames 174 having a second quality level or low quality level (that is lower in quality than the high quality level). The lossy decompression device 158 can apply decompression having a determined sampling rate corresponding to a rate at which the samples, portions, pixels or regions of the decoded video frames 172 are processed and/or compressed during lossy compression. The sampling rate can be selected based in part on the decompression rate, the loss factor, the quality metric or any combination of the decompression rate, the loss factor, and the quality metric. The lossy decompression device 158 can apply decompression to the previous video frame 734 to generate a decompressed video frame 174.

Referring to 230, and in some embodiments, a previous video frame 174 can be added to a decoded video frame 172. The second device 140, through the reference loop 154, can provide the previous video frame 174 to an adder 152 of the decoder 146. The adder 152 can combine or apply previous video frame 174 to a reconstructed video frame 172, 174 to generate a decompressed video 170. The decoder 146 can generated the decompressed video 170 such that the decompressed video 170 corresponds to, is similar or the same as the input video 130 received at the first device 102 and the encoder 106 of the video transmission system 100.

Referring to 232, and in some embodiments, a video frame 172 and/or decompressed video 170 having one or more decompressed video frames 172 can be provided to or rendered via one or more applications. The second device 140 can connect with or coupled with one or more applications for providing video streaming services and/or one or more remote devices (e.g., external to the second device, remote to the second device) hosting one or more applications for providing video streaming services. The second device 140 can provide or stream the decompressed video 170 corresponding to the input video 130 to the one or more applications. In some embodiments, one or more user sessions to the second device 140 can be established through the one or more applications. The user session can include or correspond to, but not limited to, a virtual reality session or game (e.g., VR, AR, MR experience). The second device 140 can provide or stream the decompressed video 170 corresponding to the input video 130 to the one or more user sessions using the one or more applications.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

1. A method comprising:
providing, by an encoder of a first device, a first video frame for encoding, to a prediction loop of the first device;
applying, by a lossy compression device in the prediction loop, lossy compression to the first video frame to generate a first compressed video frame;
applying, by a lossy decompression device in the prediction loop, lossy decompression to the first compressed video frame, wherein a decompression rate of the lossy decompression corresponds to a compression rate of the lossy compression; and
providing, by the encoder to a decoder of a second device to perform decoding, encoded video data corresponding to the first video frame and a configuration of the lossy compression.

2. The method of claim 1, comprising:
receiving, by the encoder, a second video frame subsequent to the first video frame;
receiving, from the prediction loop via a storage device of the first device, a decompressed video frame generated by applying the lossy decompression to the first video frame; and
estimating, by a frame predictor of the encoder, a motion metric according to the second video frame and the decompressed video frame.

3. The method of claim 1, comprising:
encoding, by the encoder, the first video frame using data from one or more previous video frames, to provide the encoded video data; and
transmitting, by the encoder, the encoded video data to the decoder of the second device.

4. The method of claim 1, further comprising causing the decoder to perform decoding of the encoded video data using the configuration of the lossy compression.

5. The method of claim 4, further comprising causing the second device to apply lossy compression in a reference loop of the second device, according to the configuration.

6. The method of claim 1, wherein providing the configuration of the lossy compression further comprises transmitting the configuration in at least one of: subband metadata, a header of a video frame transmitted from the encoder to the decoder, or a handshake message for establishing a transmission channel between the encoder and the decoder.

7. The method of claim 1, comprising:
decoding, by a decoder of the second device, the encoded video data to generate a decoded video frame; and
combining, by the second device using a reference loop of the second device, the decoded video frame and a previous decoded video frame provided by the reference loop of the second device to generate a decompressed video frame associated with the first video frame.

8. The method of claim 1, further comprising storing the first compressed video frame in a storage device in the first device rather than external to the first device.

9. The method of claim 1, further comprising storing the first compressed video frame in a static random access memory (SRAM) in the first device rather than a dynamic random access memory (DRAM) external to the first device.

10. The method of claim 1, wherein the configuration of the lossy compression comprises at least one of the compression rate of the lossy compression, the decompression rate of the lossy decompression, a loss factor, a quality metric or a sampling rate.

11. The method of claim 1, comprising:
configuring the lossy compression applied in the prediction loop of the first device and lossy compression applied by a reference loop of the second device to have a same compression rate to provide bit-identical results having the same number of bits.

12. A device comprising:
at least one processor configured to:
provide a first video frame for encoding, to a prediction loop of the device;
apply, by a lossy compression device in the prediction loop, lossy compression to the first video frame to generate a first compressed video frame; and
apply, by a lossy decompression device in the prediction loop, lossy decompression to the first compressed video frame, wherein a decompression rate of the lossy decompression corresponds to a compression rate of the lossy compression; and
an encoder configured to:
provide, to a decoder of another device to perform decoding, encoded video data corresponding to the first video frame and a configuration of the lossy compression.

13. The device of claim 12, wherein the first compressed video frame is stored in a storage device in the device rather than external to the device.

14. The device of claim 12, wherein the first compressed video frame is stored in a static random access memory (SRAM) in the device rather than a dynamic random access memory (DRAM) external to the device.

15. The device of claim 12, wherein the at least one processor is further configured to:
cause the decoder to perform decoding of the encoded video data using the configuration of the lossy compression.

16. The device of claim 12, wherein the at least one processor is further configured to:
cause the another device to apply lossy compression in a reference loop of the another device, according to the configuration.

17. The device of claim 14, wherein the configuration of the lossy compression comprises at least one of the compression rate of the lossy compression, the decompression rate of the lossy decompression, a loss factor, a quality metric or a sampling rate.

18. The device of claim 14, wherein the at least one processor is further configured to:
cause lossy compression applied by a reference loop of the another device to have a same compression rate as the lossy compression applied in the prediction loop of the device to provide bit-identical results having the same number of bits.

19. A non-transitory computer readable medium storing instructions when executed by one or more processors cause the one or more processors to:
provide a first video frame for encoding, to a prediction loop of the device;
apply, through a lossy compression device in the prediction loop, lossy compression to the first video frame to generate a first compressed video frame;
apply, through a lossy decompression device in the prediction loop, lossy decompression to the first compressed video frame, wherein a decompression rate of the lossy decompression corresponds to a compression rate of the lossy compression; and
provide, to a decoder of another device to perform decoding, encoded video data corresponding to the first video frame and a configuration of the lossy compression.

20. The non-transitory computer readable medium of claim 19, further comprising instructions when executed by the one or more processors further cause the one or more processors to:
cause the decoder to perform decoding of the encoded video data using the configuration of the lossy compression.
